(19) United States
(12) Patent Application Publication
(10) Pub. No.: US 2016/0117716 A1
(43) Pub. Date: Apr. 28, 2016

(54) METHODS AND SYSTEMS FOR ADVERTISING APPS

(71) Applicants: Hsiu-Ping Lin, Taipei (TW); Chi-Jen Wu, Tainan (TW); Hung-Pin Shih, Tainan (TW); Hung-I Tsai, Taipei (TW)

(72) Inventors: Hsiu-Ping Lin, Taipei (TW); Chi-Jen Wu, Tainan (TW); Hung-Pin Shih, Tainan (TW); Hung-I Tsai, Taipei (TW)

(21) Appl. No.: 14/591,938

(22) Filed: Jan. 8, 2015

Related U.S. Application Data
(63) Continuation-in-part of application No. 14/520,391, filed on Oct. 22, 2014.

(51) Int. Cl. G06Q 30/02; H04L 29/06

(52) U.S. Cl. CPC G06Q 30/0241; H04L 65/60

(57) ABSTRACT

The present invention relates to a method for advertising apps. The method may include the steps of providing a first part of a user interface on a first client for setting an app to be advertised, providing an app stream of the app on a second client, and transmitting a coordinate when/after the app stream is operated on the second client, and displaying a reply of the app stream on at least one of the first client, the second client and a third client.

### CROSS-REFERENCE TO RELATED APPLICATION(S)

The application is a continuation of the U.S. patent application Ser. No. 14/520,391, filed on Oct. 22, 2014, entitled “METHODS AND SYSTEMS FOR ADVERTISING APPS,” which are incorporated by reference herein in their entirety.

### TECHNICAL FIELD

The present invention relates to methods and systems for advertisements. In particular, the present invention relates to methods and systems for advertising apps.

### BACKGROUND

An app browser (Arowser™) is first disclosed and described in U.S. Provisional Patent Appl. No. 61/862,967 named “METHODS AND SYSTEMS FOR IN-APPS SEARCH AND APP BROWSERS” filed in Oct. 7, 2013. In the invention, apps may be run/executed on remote servers or cloud, and output screens or user interfaces of the apps may be transmitted or streamed from the remote server/cloud to clients and be shown on the clients (e.g., on the app browser) for users to interact with. With the help of the app browser technology, a user on his/her client may operate the apps (or interact with the apps) via the streamed user interfaces (or the app browser) without installing or executing the apps locally on the client (which means the apps are not necessarily installed/executed on the client).

Dynamic user interfaces are related inventions provided in U.S. Provisional Application No. 61/922,860 filed on Jan. 1, 2014 and U.S. Provisional Application No. 61/951,548 filed on Mar. 12, 2014 of which both are entitled “METHODS AND SYSTEMS FOR GENERATING USER INTERFACES RELATING TO APP SEARCH”. In such inventions, different from search results provided by conventional search engines (e.g., Google) or app markets (e.g., Google Play or App Store of Apple Inc.), the dynamic user interfaces may provide dynamic/interactive search results to users, and thus allow users to try or to use an app before he/she actually downloads it and installs it on a smart device (e.g., smartphone or tablet pc/pad and the app is also called a “mobile app” in this case). With the help of the dynamic user interfaces, users may know more about the app search results provided by search engines or app markets because he/she may actually operate/use apps in the app search results directly.

Unlike the traditional search engines or app markets which may only provide static/fixed information/data (e.g., text descriptions, screenshots/images or demo videos of apps) of their apps and let users to download the apps, systems adopting technology of the app browser and/or the dynamic user interface may provide not only the static/fixed information but also real apps for users to use them directly. Therefore, unlike the traditional search engines or app markets which may only provide keyword advertisings or banner/interstitial advertisement for developers to advertise/promote their apps, the systems adopting technology of the app browser and/or the dynamic user interface may be configured to provide new types of advertisements for advertising apps. Corresponding user interfaces for advertisers and/or users to add their advertisements are desirable.

### BRIEF SUMMARY

Examples of the present invention may provide a method for advertising apps. The method may include the steps of providing a first part of a user interface on a first client for setting an app to be advertised, providing an app stream of the app on a second client, and transmitting a coordinate when/after the app stream is operated on the second client, and displaying a reply of the app stream on at least one of the first client, the second client and a third client.

Some examples of the present invention may provide an advertising system. The advertising system may include an application server, a virtual machine and a streaming server. The application server may be configured to provide a first part of a user interface on a first client for setting an app to be advertised. An app package related to the app may be installed in the virtual machine to form the app run on the first virtual machine. Moreover, the streaming server may be configured to stream an app stream to a second part of the user interface to display the app stream on the second part of the user interface, and receive a coordinate of the second part of the user interface, wherein the app stream shows pixels of a surface where the app renders its content, and the coordinate is transmitted when/after the app stream is operated.

Other examples of the present invention may provide an advertising system. The advertising system may include an application server, a virtual machine, a streaming server a scrip generating module and an app control module. The application server may be configured to provide a first part of a user interface on a first client for setting an app to be advertised. An app package related to the app may be installed in the virtual machine to form the app run on the first virtual machine. The streaming server may be configured to provide an app stream of the app to a second client and receive a coordinate when/after the app stream is operated on the second client, wherein the app stream is capable of being operated on the second client as the app is being operated. The scrip generating module may be configured to generate a scrip based on the coordinate. Moreover, the app control module may be configured to operate the app or a cloned app of the app by running the script when/before being requested for displaying a reply of the app stream from at least one of the first client, the second client and a third client.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, some preferred embodiments are shown in the drawings. It should be understood, however, that the present invention is not limited to the precise arrangements and instrumentalities shown.

In the drawings:

FIG. 1 is a diagram illustrating an advertising system according to an example of the present invention;

FIG. 2 is a diagram illustrating an exemplary user interface according to an example of the present invention;

FIGS. 3A-3D are diagrams illustrating exemplary user interfaces according to an example of the present invention;

FIGS. 4A-4C are diagrams illustrating exemplary user interfaces according to another example of the present invention;

FIGS. 5A and 5B are flowcharts illustrating methods of advertising apps according to examples of the present invention; and

FIGS. 6A, 6B and 6C are flowcharts illustrating methods of advertising apps according to examples of the present invention.

### DETAILED DESCRIPTION

Reference will now be made in detail to the examples of the invention, which are illustrated in the accompanying drawings. Wherever possible, the same reference numbers will be used throughout the drawings to refer to the same or like parts.

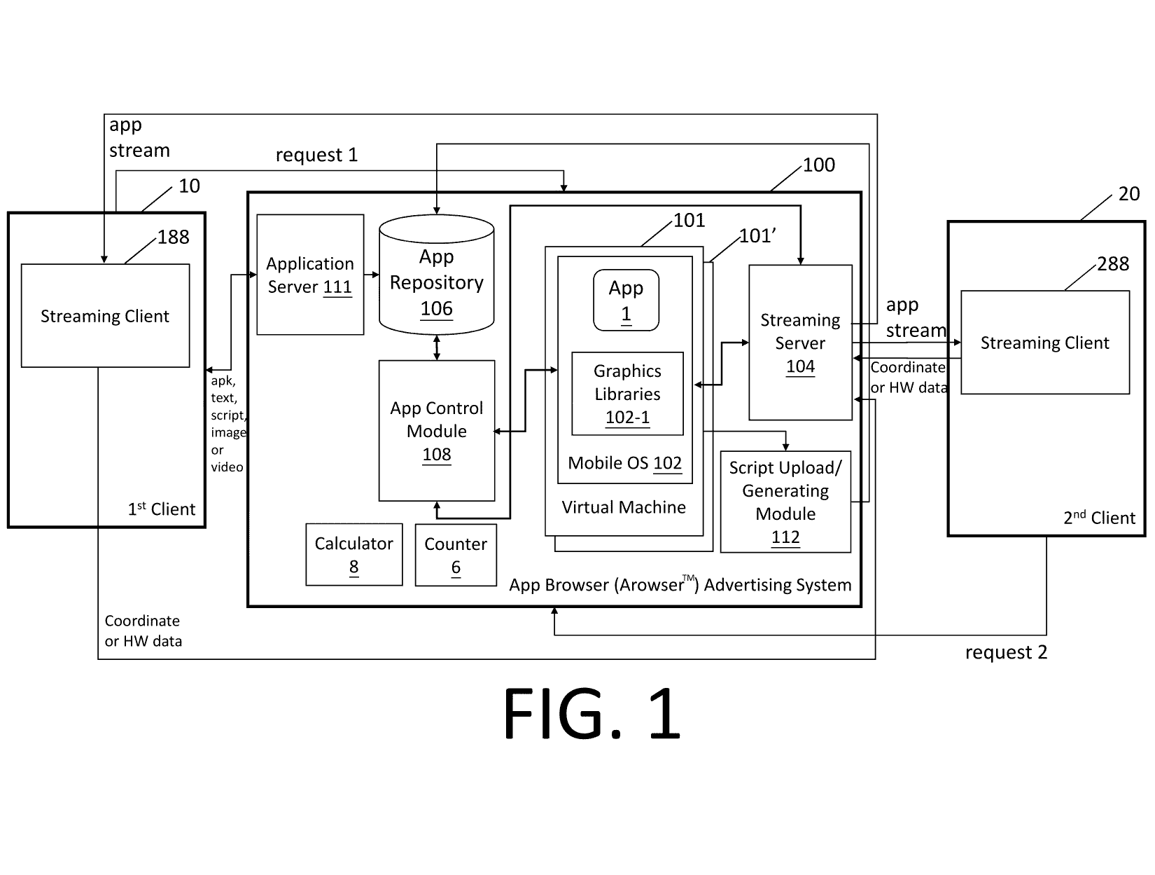

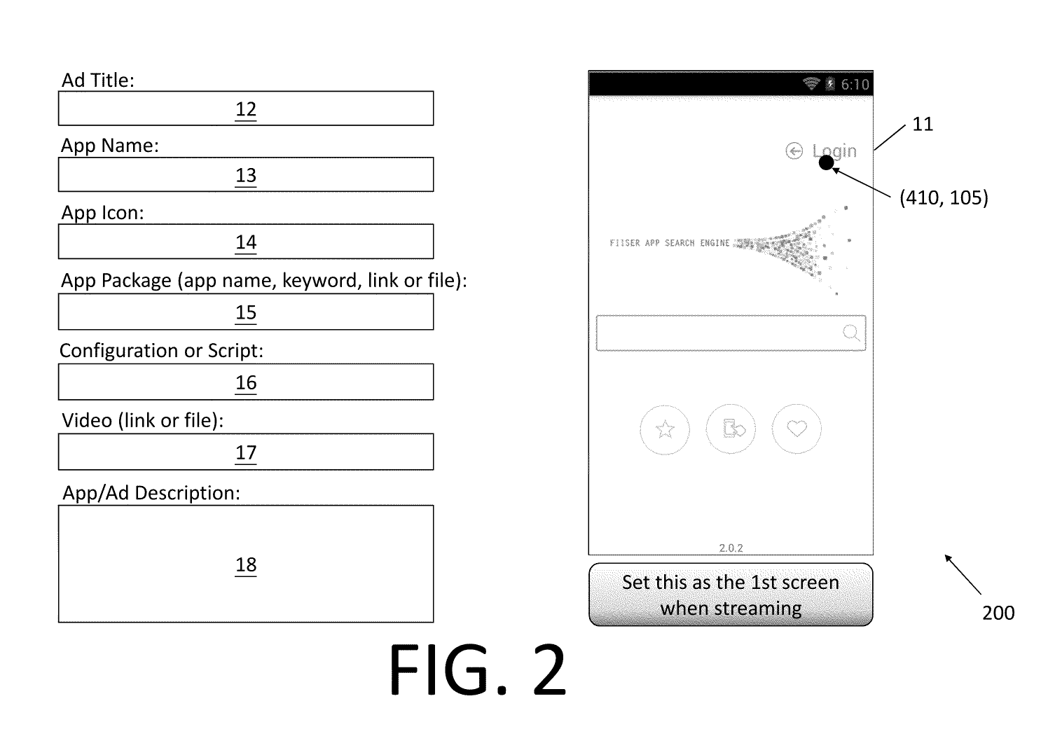

FIG. 1 is a diagram illustrating an advertising system 100 according to an example of the present invention. The advertising system 100 may be coupled with or communicate with a first client 10 or a second client 20 via internet. Referring to FIG. 1, the advertising system 100 may include an application server 111, a first virtual machine 101, a streaming server 104 or an app repository 106. In practice, each of the application server 111, the first virtual machine 101, the streaming server 104 and the app repository 106 is not necessarily implemented/provided/embodied by a single system operator or company (e.g., a third party may provide a cloud for running the first virtual machine 101 or app streaming services with the streaming server 104 to one who provide app advertising services with the application server 111). Moreover, each of which may be coupled with the other in LAN, WAN, Internet or any combination of the LAN, WAN and/or the Internet. The application server 111 may be configured to provide a first part (numbered 15 in FIG. 2) of a user interface (numbered 200 in FIG. 2) on the first client 10 for setting an app to be advertised. In one example of setting the app to be advertised, the first part 15 of the user interface 200 may be configured for transmit an app package to the advertising system 100. In this example, the app package may be transmitted (or uploaded) from the first client 10 to the advertising system 100 after the first user generates a request for establishing a connection for transmitting the app package from the first client 10 to the advertising system 100. In another example, a user may set an app to be advertised by submitting a link, which may be used to link to a source for downloading the app package (e.g., a URL of an app market such as Google Play or App Store which the user may download the app package from, hereinafter a “download source”), with the first part 15 of the user interface 200. The advertising system 100 is configured to download or fetch the app package from the download source directed by the link after receiving the link in this example. In other examples, a user may submit a keyword of/related to an app name (or submit exactly the app name) or a description of an app with the first part 15 of the user interface 200 for setting an app to be advertised. In this example, a plurality of app packages may be stored in the app repository 106 in advance. The advertising system 100 may then search for an app package corresponding to the keyword, and install the found app package in the first virtual machine 101. In another example, if an app package is not stored in advance in the advertising system 100, or an app package(s) related to the keyword is not found, a crawler (which is a module/program for finding and/or downloading app packages, not shown in FIG. 1) coupled with or included in the advertising system 100 may be configured to crawl the corresponding app package(s) back, and the advertising system 100 may then install the crawled app package(s) in the first virtual machine 101. Moreover, the crawled app package(s) may be stored in the app repository 106. More details of the user interface 200 will be described and illustrated with reference to FIG. 2.

In one example, the app package may be installed in the first virtual machine 101 running a mobile OS 102 to form an app 1 run on the first virtual machine 101. The app package may be an Android apk file or an iOS ipa file and the mobile OS 102 may be Android or iOS, respectively.

The streaming server 104 may be configured to stream an app stream to a second part (numbered 11 in FIG. 2) of the user interface 200 to be displayed on the second part 11 of the user interface 200. In one example, when displaying the app stream on the second part 11, it shows pixels (or pixel data) or screen outputs corresponding to a surface (i.e., a screen buffer) where the app 1 renders its content. When the app 1 renders things, no matter what graphics API (or rendering API) it uses, things are rendered onto the surface, which is a screen buffer of pixel data. Take Android as an example, a surface in Android corresponds to an off-screen buffer into which an app renders its content. Every window that is created on the Android platform is backed by a surface. After rendering, the screen outputs of the app 1 is transmitted to the first client 10 as the app stream to be displayed on the second part 11 of the user interface 200 (i.e., streamed screen outputs of the app 1). Those skilled in the art may understand that other kinds of mobile OSs (e.g., iOS) may have similar mechanisms for their apps to render things, and thus the term “surface” used in this specification should not be limited to Android platforms. In this example, a user at the first client 10 may operate the second part 11 of the user interface 200 with a cursor (e.g., the user interface is implemented as a webpage and the user may operate/interact views/elements on the streamed output screens of the app shown on the second part 11 of the user interface 200 with the cursor) or touch screen (e.g., the second part 11 of the user interface 200 is shown on a touch screen such that the user may operate/interact views/elements on the streamed output screens of the app). Coordinates (representing points on the second part 11 of the user interface 200) of touched point(s) or moving trajectories of the user's finger or cursor when operating the second part 11 of the user interface 200 may then be transmitted to the advertising system 100. In this example, the user may control the app remotely.

When the app 1 is run, executed or operated in the mobile OS 102 on the first virtual machine 101, rendering commands (e.g., OPENGL or OPENGLES command(s)) or a texture(s) for rendering screen outputs of the app 1 is generated. Conventionally, new output screens will be rendered based on the rendering commands (and sometimes with the texture(s)). In the aforementioned or some other examples of the present invention, the output screen is streamed to the first client 10 for the user to use the app 1 from the first client 10. However, different from being rendered in the first virtual machine 101 or the advertising system 100 and then streamed to the first client 10, in another example of the present invention, the app stream transmitted to the first client 10 may include a texture or a corresponding command to draw a screen output of the app 1 on the first client 10. In this example, the output screen is rendered on the first client 10 instead of being rendered before being streamed and what actually being streamed/transmitted is only the texture and/or the commands for rendering. In this example, the command is executed on the first client 10 instead of being executed on the first virtual machine 101, and thus what is included in the app stream is only the rendering command and/or its corresponding texture, but not a streamed screen output(s).

In still another example, textures for rendering output screen of the app 1 may be stored on the first client 10 previously and thus it is not necessary to transmit all the textures to be rendered each time.

In other examples, such as coupling the user interface 200 including the first part 15 and the second part 11 with an app/program (not shown) which calls hardware-related API/SDK run/executed on a smart device (in this example the first client 10 is the smart device), and/or such as displaying the user interface 200 on a screen of the smart device (could be a kind of client 10 or 20 in this example) having hardware included but not limited to a Bluetooth module, Wi-Fi module, GPU, camera module, NFC module, voice/audio/mic phone, GPS module, thermometer, gyroscope, magnetometer, barometer, lamination sensor, proximity sensor, hygrometer and/or accelerometer or other sensors or chips, the app/program generating/coupled with the user interface 200 may be configured to gather/receive hardware data including but not limited to longitudes, latitudes, acceleration force (e.g., in m/s²), ambient temperature (e.g., in ° C.), force of gravity (e.g., in m/s²), rate of rotation (e.g., in rad/s), ambient light level (illumination, e.g., in 1×), geomagnetic field, ambient air pressure (e.g., in hPa or mbar), proximity of an object relative to the view screen of the smart device (e.g., in cm), relative ambient humidity (e.g., in %), etc., generated from corresponding hardware when the user interface 200 or the app/program is operated by a user on the first client 10, and to transmit the hardware data generated on the first client 10 to the advertising system 100.

To the app 1, conventionally an input event is generated by intercepting events from a user's interaction with a user interface of the app 1 (not shown in the figures). In the examples of the present invention, the input event may be generated when an app control module 108 generates/simulates an input event/interaction to the app 1 corresponding to the received coordinate or hardware data transmitted from the first client 10. The app control module 108 is configured to generate input events to control the app 1 from the received coordinates or hardware data. For example, when receiving a coordinate (410, 105), which means a point (410, 105) of/on the second part 11 of the user interface 200 is touched/clicked, the app control module 108 may generate an input event (e.g., a touch event marked as “touch (410, 105)”) of/related to simulate touching of a point with a coordinate (410, 105) on a “virtual” user interface (or screen output) of the app 1. The “virtual” user interface or the screen output of the app 1 here means it may be invisible to the user on the first client 10 because the app 1 may only write data for rendering the screen output into a corresponding surface but not display with a real display device or GPU in the advertising system 100. Other kinds of input events may also be generated in the way similar to the example of generating the aforementioned touch event (e.g., input events for inputting tilts, rates of rotation, acceleration values, pressure values, etc., to the app 1 generated after receiving corresponding hardware data from the first client 10).

In other example, if the user interface 200 is shown on a screen output of an app (not shown, the app in this example may include a browser, a web program/JavaScript or a native mobile app) run on a smart device (e.g., a smartphone or tablet), the input event may be generated on the first client 10 (e.g., if a user operates the second part 11 of the user interface 200 by tapping/touching the point with the coordinate (410, 105) on the second part 11, an input event “touch (410, 105)” may be generated by the app on the first client 10 locally. Later, the input event “touch (410, 105)” may be transmitted to the app 1 and treated as an input event to control the app 1, or transmitted to the app control module 108 to be converted to the touch event for the app 1. Moreover, other kinds of input events related to hardware data may also be generated similarly. In this example, the app displaying the user interface 200 receives and/or generates event inputs for the app 1 in the advertising system 100.

In one example, the advertising system 100 may further include a script generating module 112. The script generating module 112 may be configured to generate a script based on the input event generated by the app control module 108. An exemplary script stored in the advertising system 100 may be shown below (it is written in Python and of which the app control module 108 is called by “AppControl” in this example):

```
from com.fiiser.appcontrol import AppControl, AppDevice
import os, sys
timeout = 3600 # seconds
apkPath = os.path.abspath(__file__).replace(″py″, ″apk″)
# Connects to the current device
device = AppControl.waitForConnection(timeout, deviceSerialNumber)
  package = ′com.fiiser.arowser′
  installed_apk_path = device.shell(′pm path com.fiiser.arowser′)
  device.installPackage(apkPath)
  AppControl.sleep(3)
  activity = ′com.fiiser.arowser.main.NewsTabActivity′
  device.startActivity(component=runComponent)
  # Presses the Menu button
  device.press(′KEYCODE_MENU′, AppDevice.DOWN_AND_UP)
  AppControl.sleep(5)
  device.touch(410, 105, ′DOWN_AND_UP′)
  AppControl.sleep(5)
  device.press(′KEYCODE_BACK′, AppDevice.DOWN_AND_UP)
  AppControl.sleep(5)
  device.press(′KEYCODE_HOME′, AppDevice.DOWN_AND_UP)
```

In this example, the app control module 108 may be configured to operate the app 1 or a clone of the app 1 (in this case the app control module 108 may clone the app 1 first and then operate the cloned app) by running the script when/before being requested to run the app 1 from the first client 10 or the second client 20 (i.e., users on the client 10 or 20 may request for receiving/using the appstream of the app 1 for interacting with the app 1 in this example). Users on the first client 10 could be advertisers or app developers who want to promote/advertise apps, and users on the second client 20 could be normal users who request for and/or receive the app streams. By running the script, the app control module 108 may generate input events corresponding to the script.

In one example, when receiving a request for operating the app 1 run on the mobile OS 102 on the virtual machine 101 from the second client 20, the app control module 108 may clone a new copy of the app 1 (hereinafter the “cloned app”) on the original mobile OS 102 of the virtual machine 101, or in a new (second) virtual machine 101′ running a new/same mobile OS (not shown and numbered). An app stream of the cloned app may be streamed/transmitted to the second client 20 by the streaming server 104, and thus a user(s) on the second client 20 may operate the cloned app remotely. In another example, the app package may be installed in the virtual machine 101′ once receiving the request for operating the app 1 from the second client 20. In this example, a new app 1 (or a cloned app) may be formed on the mobile OS in the virtual machine 101′. From the above two examples of the present invention, methods to provide app streams of the app 1 to users on the first or second client 10 or 20 may include at least one of cloning the app 1, cloning the entire virtual machine 101 including the app 1 and installing the app package to form a new app 1 (i.e., to install the app package in the original virtual machine 101 or another virtual machine such as the virtual machine 101′, and the later means the app package may need to be transmitted to the new virtual machine 101′ first and then be installed in the new virtual machine 101′).

When advertising an app (e.g., the app 1) to a user or an audience on the second client 20, or when a user requests for operating the app 1 from the second client 20, the app stream of the app 1 or the cloned app is streamed/transmitted to a user interface on the second client 20 to be displayed and/or used/operated similarly or in the way like the user/advertiser operates the second part 11 of the user interface 200 (i.e., by clicking/touching a view/element including but is not limited to a button, a banner, a link, a region or an item shown on a screen output of the app stream and transmitting corresponding coordinates/hardware data to the advertising system 100 for generating corresponding input event(s) to the app 1 or a cloned app of the app 1 run in the advertising system 100).

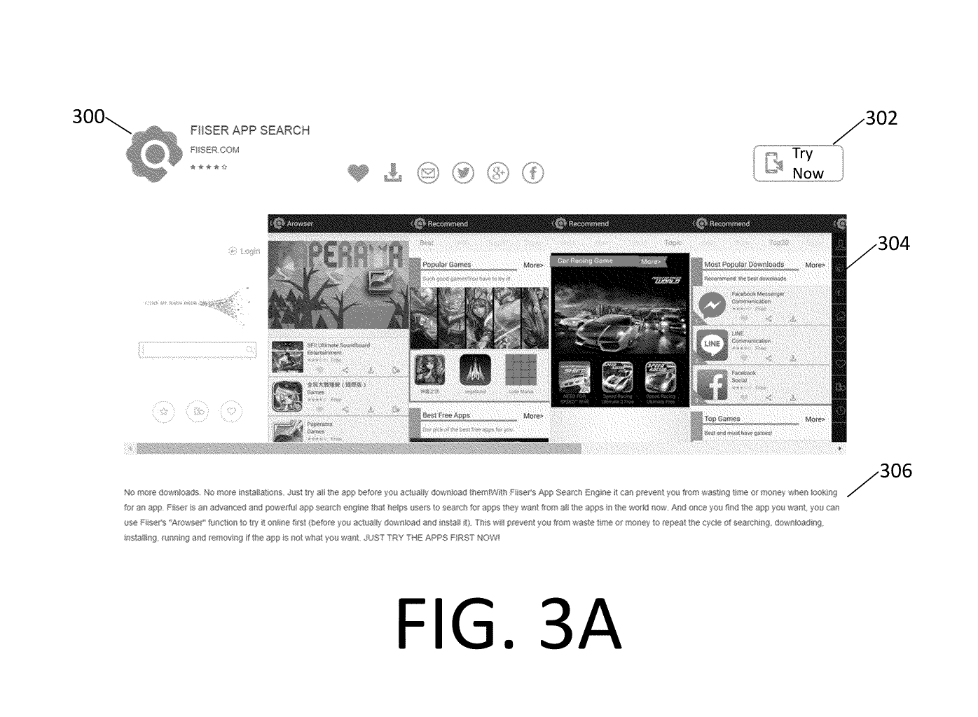

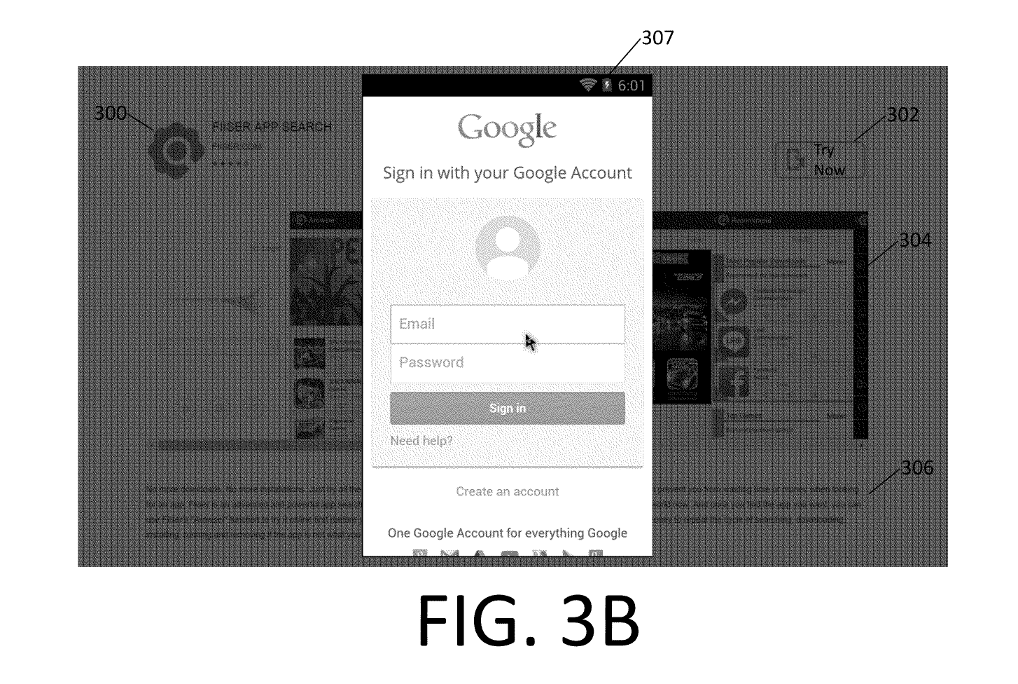

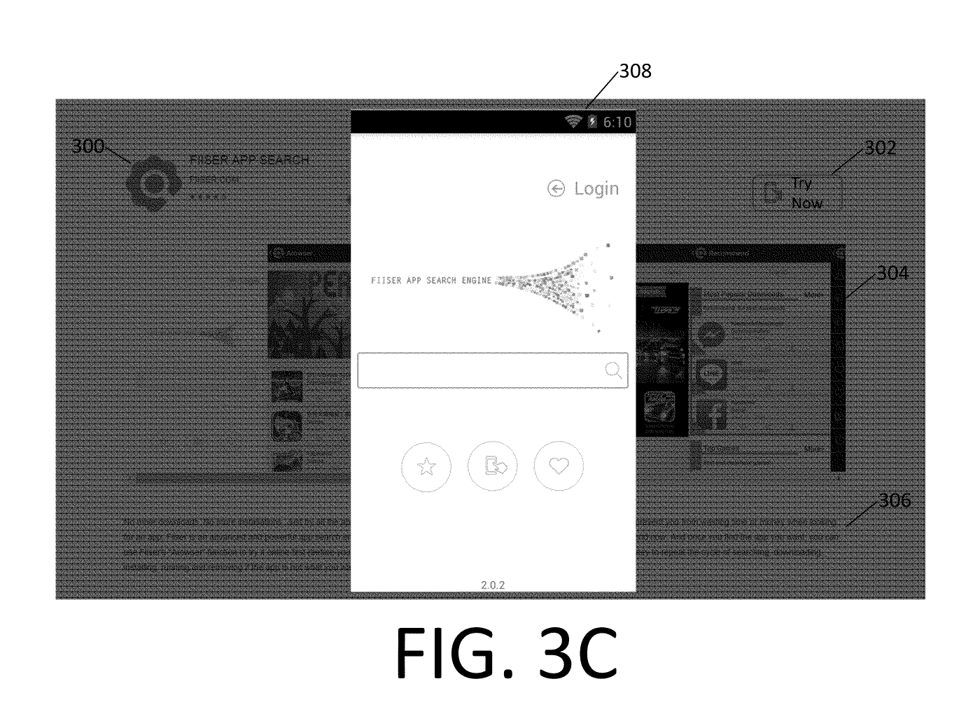

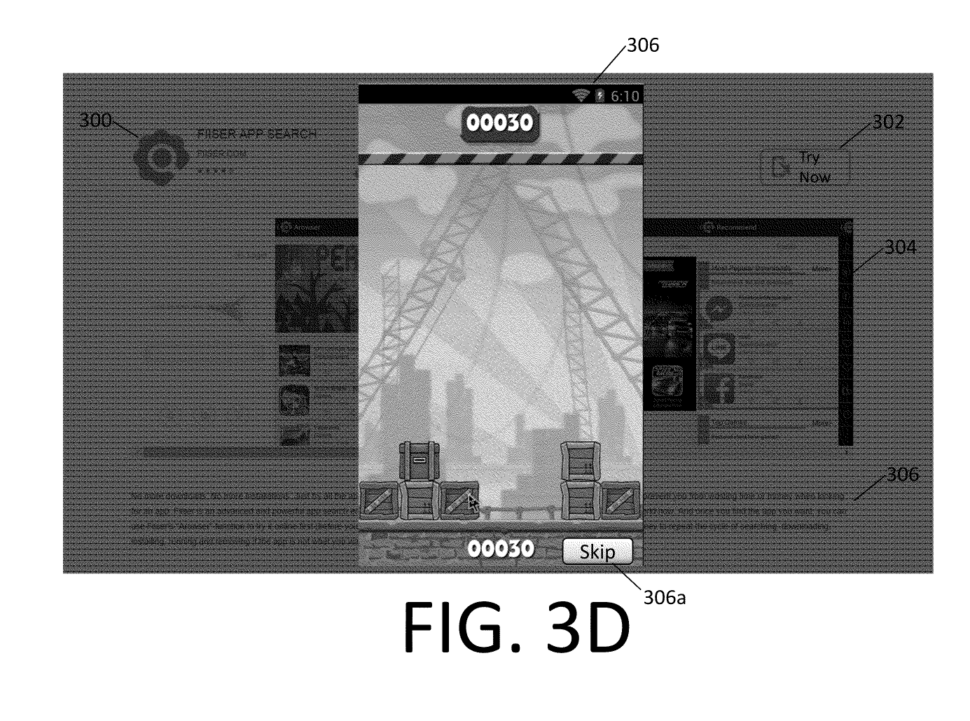

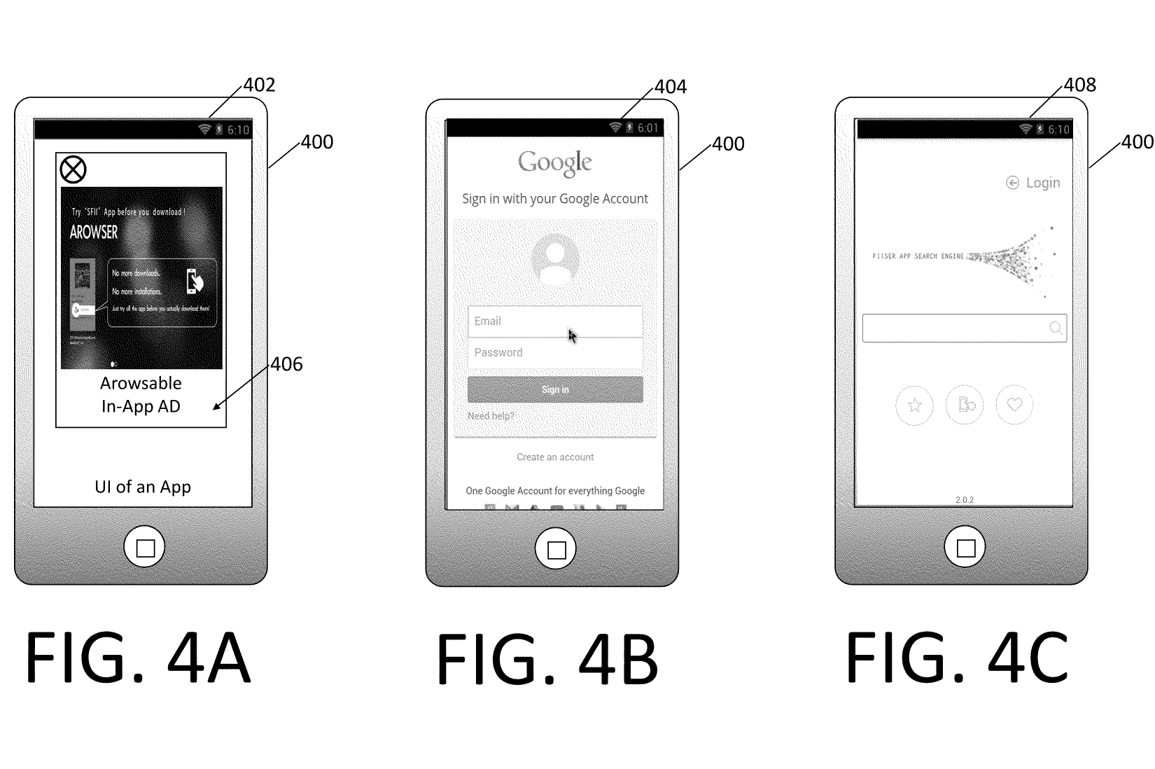

Sometimes, some apps (including the app 1/the cloned app in the examples of the present invention) may include an advertisement page (in-app ad), an opening screen(s)/activating page(s) or a login page (e.g., such as the window (or the output screen) 307 or 404 shown in FIG. 3B or 4B) to ask users to login first at the beginning or during the operation of the apps. Although to allow users to try an app by trying its app stream(s) with the app browser technology before he/she downloads/installs the app is already much more convenient than the traditional ways that users may only try apps after downloading and installing the apps each by each, sometimes it may make users or audiences inconvenient or confused when streaming some apps that require users to go through an extra procedure(s) (e.g., to login, to close an in-app ad window, or to finish the activating/opening screen/page), especially when they only want to try/use a main or real function (e.g., such as the window (or the output screen) 308 or 408 shown in FIG. 3C or 4C) of the apps with app streams of the apps before downloading/installing. For example, just think about if a user keys in a keyword “batman” and he/she receives dozens of apps related to “batman” as search results. If the user wants to try each or some of the batman apps shown in the search results and then decides which to use/download, he/she may not want to see an irrelevant ad(s)/information, to login the app(s) actually (since he/she even has not decided to download the app(s) or not) or to close/turn-off an in-app ad(s) shown on a beginning or middle of the app(s) before trying a main/real function of these app(s). On the other hand, if an advertiser wants to advertise an app, he/she may not want/like audiences/users to see other's in-app ad(s) when seeing/operating/interacting with the output screen(s) in an app stream of his/her app.

In another example, the app 1 may be more attractive, featured or special (or the advertiser or the user on the first client 10 may consider it to be more attractive, featured or special) to users in a certain stage/part/page/window/view/activity/subprogram of the app 1 than other parts of the app 1, and the advertiser/user on the first client 10 should be able to switch/operate the app 1 to make it demonstrate/render the user interface/screen output of the more attractive/special/featured stage/part/page/window/view/activity/subprogram to attract the audience to use the app 1 or to catch the audience's eyes. When advertising these kinds of the apps (i.e., apps got in-app ad or login page, etc. to be skipped in its corresponding app stream or be more special/featured in certain parts), with the help of the advertising system 100, the apps may be started (or the app streams of the apps may be started) in some predetermined configurations/conditions or from certain starting points (or break points).

In one example, when an advertiser/user tries to add an app advertisement with the user interface 200, after setting the app to be advertised by selecting a corresponding app package of the app in the app repository 106, uploading the corresponding app package, or submitting a link to get the app package via the first part 15 of the user interface 200, the app package may be received by the application server 111 and stored in the app repository 106. Later, the app control module 108 will fetch the app package from the app repository 106 and install it to form the app (to be advertised) in the mobile OS 102 on the virtual machine 101. In this example, the app to be advertised is run on the virtual machine 101 and an app stream of the app is streamed/transmitted by the streaming server 104 to the first client 10 and displayed on the second part 11 of the user interface 200.

After the app stream is displayed, the advertiser/user may operate the app on the virtual machine 101 by operating an output screen of the app shown on the second part 11 of the user interface 200. In one example, the advertiser/user may operate to open a certain page of the app or make the app switch to a certain mode/status/condition. Examples of the page or mode/status/condition may be referred to those screen outputs shown in FIGS. 3B-3D, 4B and/or 4C. For example, the app may be developed to be activated with a screen output that asks/requires login (such as those shown in FIG. 3B or 4B) before providing a main function or a most attractive part of the app (e.g., such as the window (or the output screen) 308 or 408 shown in FIG. 3C or 4C) to its users. In this example, the advertiser/user may want to skip the login page of the app and let audiences/users to try the main function directly when they receive the app stream of the app advertisement. In this example, the advertiser/user may operate the app to be advertised with the second part 11 of the user interface 200 to a condition/status/mode (or to show a page or with a configuration) like those shown in FIG. 3C or 4C, and then submitting the app advertisement of the app (e.g., the user interface 200 may further include a button that reads “Set this as the first screen when streaming”). After submitting the app advertisement, the condition, status or mode of the app, or the configuration of the app or the mobile OS/virtual machine after the app is operated, will be kept “AS IS”. For example, as an Android app having a plurality of activities, an activity may be switched to another activity with an intent, and the intent may include a parameter and/or data for the new activity. Exemplary codes may be shown as follows:

### Example 1

Intent intent = new Intent(A.this, B.class);
startActivity(intent); //switched to the new activity.

### Example 2

Intent intent = new Intent(A.this, B.class);
Intent .putExtra(“name” , name); //bring the parameter “name”
to the new activity.
startActivity(intent); //switched to the new activity.

In this example, when the Android app is operated, intents may be transmitted between different activities (e.g., switch to a certain page of the app with a certain intent including some parameters). And in this example, the intents may be kept as the configuration or the mode of the app.

Take the app 1 as an exemplary app to be advertised (or say the advertised app) with the advertising system 100. The method(s) for keeping the app to be started in the condition, status or with the configuration of may be described in any of the following examples of the present invention:

### Example 1

### Generating an Image File

After the advertiser/user operates the screen output of the app 1 displayed on the second part 11 of the user interface 200 (which is streamed as the app stream to be displayed on the second part 11) when a user/advertiser adds an app advertisement, coordinates and/or hardware data are transmitted to the advertising system 100 if the screen output is operated by the user/advertiser. The app control module 108 may generate corresponding input events and operates the app 1 run in the mobile OS 102 on the first virtual machine 101 accordingly to the input events. The app 1 may take a response(s) to the input events, for example, in response to the input events, the app 1 may configure itself, generate new screen output(s), switch to another mode, page or initiate new/another/other function(s)/activities. After the app 1 takes the response(s) to the input events, an image file of the first virtual machine 101 including the changed app 1 (which has taken the response to the input events) is generated. The image file may further include at least one of a setting/configuration of the mobile OS 102, a setting/configuration of the first virtual machine 101, the mobile OS 102 and the first virtual machine 101 in this example.

Moreover, the image file may be written to a machine (computing device) or a virtual machine to rebuild/reconstruct a mobile OS 102 with an app 1 run on it with the same setting(s)/configuration(s). The reconstruction may be configured to be done before/when receiving a request for transmitting/streaming the app stream of the app 1 to the client 20 to be the app advertisement of the app 1. In this example, the image file may be written to the virtual machine 101, or a clone (or a new) virtual machine (e.g., the second virtual machine 101′ or other virtual machine(s)), and after the reconstruction, the app 1 in the mobile OS/virtual machine may be activated/started in similar or exact the same condition/status/configuration/setting(s) (or some view/part/mode in the app 1 or the cloned app) when the advertiser/user originally operates the second part 11 of the user interface 200 to add the app advertisement for the app 1. Therefore, when a user on the second client 20 starts to receive the app stream of the app 1, it starts at the condition/status/configuration/setting/place(s) previously set by the advertiser/user who adds the app advertisement.

In one example, technologies for generating the image file may include but is not limited to technologies similar to (or modified/improved from) Ghost, an acronym for general hardware-oriented system transfer which is a discontinued disk cloning and backup tool.

### Example 2

### Generating a Script

The Example 2 may be similar to the Example 1, except that, the input events are compiled to become a script (or add into a script) after the advertiser/user operate the app 1 (remotely with the app stream of the app 1 shown on the second part 11 of the user interface 200). The script of the input events may be similar to the exemplary script mentioned above. In this example, when/before receiving a request for transmitting/streaming the app stream of the app 1 to the client 20 to be the app advertisement of the app 1, the app 1 or a clone/copy of the app 1 is operated by the app control module 108 with the script (i.e., the app control module 108 may operate the app 1 or the clone app by generating input events defined/named/described in the script, in other words, the app control module 108 running the script). After the operation, the app 1 or the clone app may be activated/started in similar or exact the same condition/status/configuration/setting(s) (or some view/part/mode in the app 1 or the cloned app) when the advertiser/user originally operates the second part 11 of the user interface 200 to add the app advertisement for the app 1. Similarly, when a user on the second client 20 starts to receive the app stream of the app 1, the app stream (of the app 1 or the clone of the app 1) starts at the condition/status/configuration/setting/place(s) previously set by the advertiser/user who adds the app advertisement.

### Example 3

### Receiving a Script

The Example 3 may be similar to the Example 2, except that, the script is not necessarily generated from the input event(s). It may also be submitted/uploaded by the advertiser/user with the third part 16 of the user interface 200.

### Example 4

### Generating a Configuration of the App

Some apps may include predetermined stages, breakpoints or parts that may be switched to each/some of which by configuring the apps with different configurations. In this example, after the advertiser/user operates the app 1, the configuration of the app 1 in that condition may be stored. Later, when/before receiving a request for transmitting/streaming the app stream of the app 1 to the client 20 to be the app advertisement of the app 1, the app 1 or a clone of the app 1 may be configured by the app control module 108 according to the configuration previously. Similarly, when a user on the second client 20 starts to receive the app stream of the app 1, the app stream of the app 1 or the clone of the app 1 may start at the condition/status/configuration/setting/place(s) previously set by the advertiser/user who adds the app advertisement.

### Example 5

### Receiving a Configuration of the App

Example 4 may be similar to Example 3, except that, the configuration is not necessarily be generated. It may also be submitted/uploaded by the advertiser/user with the third part 16 of the user interface 200.

In other example, when a user/audience on the second client 20 uses/operates the advertised app with the app stream, a counter 6 can be configured to count the duration of the time the user uses/operates the app stream, and then a calculator 8 can be configured to calculate advertising fee based on duration and/or the number of times the users/audiences pay attention/stay to use/operate the app stream.

Similarly, when a user operates an app stream of an app in the aforementioned way(s), a condition/status/configuration/setting/place of the app can also be kept/stored/freezed when a session for streaming the app stream is interrupted/stopped (e.g., lose a Wi-Fi or 3G/4G signal of a smartphone or tablet PC, or the user just closes the connection of the app stream). Subsequently, when the user comes back to use the app with the app stream, the app can be streamed from the condition/status/configuration/setting/place of the app.

Moreover, the app repository 106 may be configured to store a coordinate, the input event(s) of the app 1, the script for operating the app 1, the configuration of the app 1, the configuration of the mobile OS 102 or the aforementioned image file(s).

In another example of the present invention, the advertising system 100 may further include an app search engine or may be configured to couple with an app search engine (not shown in FIG. 1). Examples of the app search engine may be referred to U.S. patent application Ser. No. 13/960,779, filed on Aug. 6, 2013, entitled “METHODS AND SYSTEMS FOR SEARCHING SOFTWARE APPLICATIONS,” U.S. patent application Ser. No. 14/258,016, filed on Apr. 22, 2014, entitled “METHODS AND SYSTEMS FOR SEARCHING SOFTWARE APPLICATIONS,” U.S. patent application Ser. No. 14/453,615, filed on Aug. 7, 2014, entitled “METHODS AND SYSTEMS FOR SEARCHING SOFTWARE APPLICATIONS,” and those described and illustrated in the aforementioned provisional applications the application of the present invention claims with. The app search engine may be configured to crawl data of apps in an app market or collect/download app packages of the apps from the app market or other download source(s). In an example that the app search engine previously collected a plurality of app packages including the one of the app which the advertiser/user wants to add the app advertisement for, the collected app packages (or copies of the collected app packages) previously stored (e.g., in the app repository 106) and the advertising system 100 including or being configured to couple with the app search engine, the advertiser/user may key in a keyword related to the app (e.g., a name of the app or a keyword in a description of the app) via the first part 11 of the user interface 200, and the app search engine or the app control module 108 will fetch the app package (e.g., from the app repository 106) corresponding to the keyword and install the app in the mobile OS 102 on the virtual machine 101.

FIG. 2 is a diagram illustrating an exemplary user interface 200 according to the aforementioned example of the present invention. Referring to FIG. 2, the user interface 200 may be configured to be shown on a browser or an output screen of an app for advertisers to set up apps to be advertised. Except the previously described part(s), the user interface 200 may further include a field 12 for inputting advertisement title, a field 13 for giving an app name, a field/interface 14 for uploading/setting an app icon or image (which may also to a link to link to the app icon or image), a field/interface 17 for uploading/setting a video/link to the video, or a field 18 to add a description for the app or the app advertisement. Those skilled in the art may understand that the present invention should not be limited to the aforementioned fields. Also, some of the fields may be optional in the aforementioned examples of the present invention.

Moreover, those skilled in the art may understand that the aforementioned virtual machine(s) or streaming server(s) is not necessarily provided by the same provider who provides the advertising system(s) of the present invention. In some examples, providers who provide the advertising systems of the present invention may receive services from other providers who provide network services (or cloud services) including the streaming servers and/or the virtual machines hosting/running the apps to be advertised with the advertising system. In other words, one who provides the advertising system(s) may only provide the aforementioned user interface(s) including the first part and the second part for advertisers to submit links, descriptions or app packages, and setting up the beginning condition or point of their apps which/where they want their advertising audiences to try when advertising their apps with the methods and/or the advertising system according to the example(s) of the present invention.

Furthermore, those skilled in the art may understand that although some of the aforementioned examples of the present invention apply an architecture of using the virtual machines to run the mobile OS(s) and the app(s), the app(s) may also be run/executed on the mobile OS(s) run on a real computing device which is running the mobile OS(s) directly without the virtual machine(s). For example, an Android app may be run on either a virtual machine that runs Android OS or an Android smartphone or tablet (or a server that runs Android OS instead of Windows-/Linux-based OS). In this example, the virtual machine(s) is not necessary. Moreover, when scaling out the number of apps that may be streamed to users on their clients, more computing devices may be added into the advertising system for providing corresponding services in this example (instead of using a hypervisor and/or a plurality of virtual machines to allow concurrent runs of a plurality of virtual machines, mobile OSs or apps).

FIGS. 3A-3D are diagrams illustrating exemplary user interfaces according to an example of the present invention. Referring to FIG. 3A, an introduction page of an app (e.g., the app 1) is shown. The page may include an app name and/or logo 300, some snapshots 304 of this app and an app description 306 of this app. Moreover, the page may include a button 302 (e.g., “try now” or “try it now”). When a user clicks the button 302, a window for displaying an app stream of the app will be shown (e.g., windows 306, 307 or 308 in FIG. 3B, 3C or 3D).

In some examples of the present invention, a webpage or an app may be configured to receive the app stream of/as the app advertisement with a corresponding API or SDK for receiving the app advertisement. Those skilled in the art may easily understand that except that the user interface(s) shown in FIGS. 3A-3D is displayed on a screen of a PC (a desktop or laptop computer), it may also be displayed on a screen of a smart device, such as a smartphone or a tablet.

In one example of the present invention which an app search engine (e.g., such as the app search engine as aforementioned) is also included or coupled with the advertising system 100, a user may search an app he/she wants/prefers (hereinafter the “user-selected app”) with the app search engine and get an corresponding app stream (hereinafter the “user-initiated app stream”) of the user-selected app by the help of the aforementioned technologies including app search engine(s) and the app browser(s). In addition to receive/use/operate the user-initiated app stream, he/she may also receive/use/operate an app stream of an app to be advertised (such as the aforementioned app 1 set by the advertiser, hereinafter the “advertising app stream”). An exemplary screen output of the user-initiated app screen may be shown as the window 308 in FIG. 3C or the output screen 408 in FIG. 4C, and an exemplary screen output of the advertising app stream may be shown as the window 306 in FIG. 3D. Note that the user-initiated app stream may be displayed before or after the advertising app on the client (e.g., the second client 20), or the user-initiated app stream may be intercepted by the advertising app stream, and after the advertising app stream is over/closed, it will switch back to stream the original user-initiated app stream or the rest of the user-initiated app stream. The “interception” here means to insert into the user-initiated app stream (i.e., to stop the display of the user-initiated app stream and display the advertising app stream) or to display the advertising app stream before/after displaying the user-initiated app stream. For example, the advertising app stream may be inserted into the user-initiated app stream including being inserted before the beginning of the user-initiated app stream.

In this example, the user-initiated app stream may include screen outputs of the user-selected app of which each screen output may include pixels corresponding to a surface (hereinafter the “first surface”) where the user-selected app renders its content or at least one of a commands and texture (when necessary) to draw the output screen of the user-selected app on the client (e.g., the second client 20). After the screen output is operated by the user on the client (or after receiving a user input related to interaction to the screen output), hardware data or a coordinate of the screen output may be transmitted from the client to the advertising system or those hosting the user-selected app and providing the user-initiated app stream. Moreover, the advertising app stream may include screen outputs of the advertised app (the app to be advertised) of which each screen output may include pixels corresponding to a surface (hereinafter the “second surface”) where the advertised app renders its content or at least one of a texture and a corresponding command (i.e. a rendering command) to draw the output screen of the advertised app on the client.

In another example, a skip button 306a may be provided for skipping the advertising app stream and switching to the user-initiated app stream, as shown in FIG. 3D.

Moreover, the aforementioned app stream(s) may also be shown with/on an output screen of an app on a smart device 400 (which is the second client 20 in this example), such as a page/window/output screen 404 or 408 shown in FIG. 4B or 4C.

Furthermore, FIG. 4A is a diagram illustrating an exemplary in-app advertisement (IAD) 406 according to an example of the present invention. Referring to FIG. 4A, the IAD 406 is shown on an output screen 402 of an app. In this example, the app is configured with an SDK related to the IAD 406 to make it receives/shows the IAD 406 on its output screen. In one example, an advertised app stream is displayed as the IAD 406 once the IAD 406 is displayed on the output screen 402. In another example, the IAD 406 may be just an interstitial, a banner or customized page/overlay for advertising another app, and after being clicked/touched by a user (on the second client 20 as aforementioned), the app stream including the output screen 404 and/or 408 is displayed/streamed on the second client 20 (or the smart device 400), as shown in FIG. 4B or 4C.

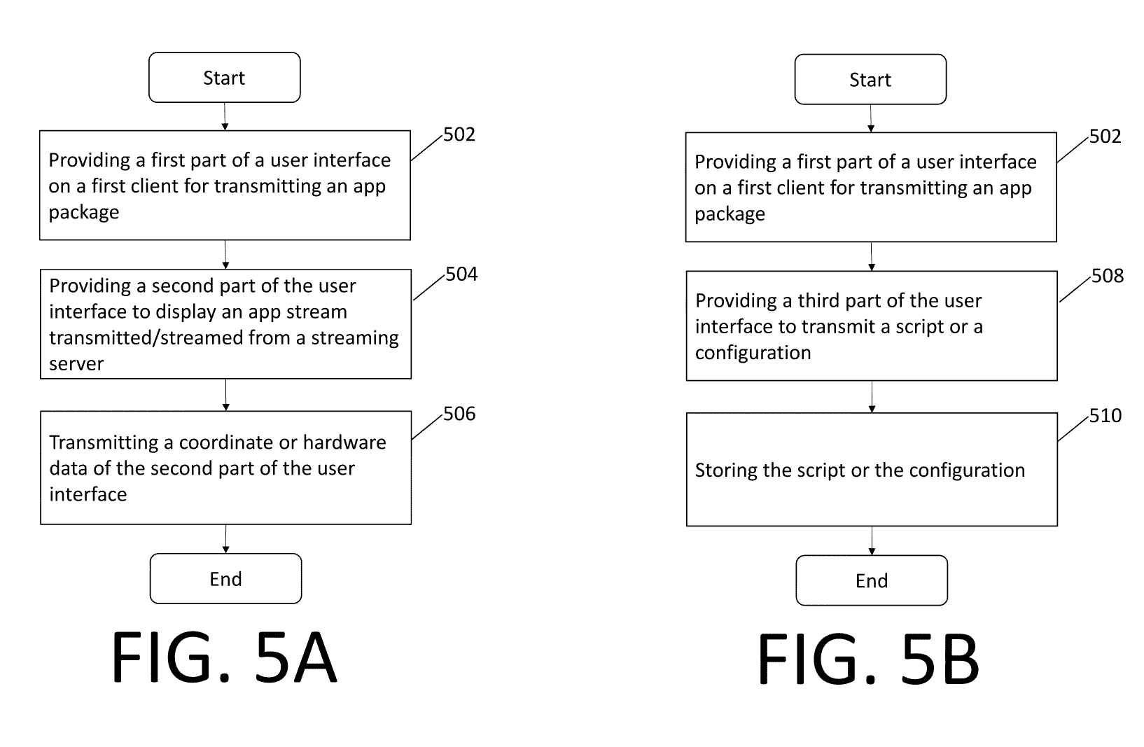

FIG. 5A is a flowcharts illustrating methods of advertising apps according to an example of the present invention. Referring to FIG. 5A, in step 502, the first part 15 of the user interface 200 is provided on the first client 10 for transmitting the app package of the app 1 to the advertising system 100. In step 504, the second part 11 of the user interface 200 is provided on the first client 10 to display the app stream of the app 1. Moreover, in step 506, a coordinate(s) of the second part 11 of the user interface 200 is transmitted from the client 10 to the advertising system 100.

In one example, the app package is transmitted to be installed in the first virtual machine 101 running the mobile OS 102 to form the app 1 run on the mobile OS 102.

In one example, the app stream shows pixels corresponding to the surface where the app 1 renders its content. In another example, the app stream includes at least one of a texture and a corresponding command to draw a screen output of the app 1 on the first client 10.

In one example, the method may further include a step of transmitting hardware data generated on the first client 10 to the advertising system 100.

In one example, the method may further include steps of generating a scrip based on the input event, and storing the script in the advertising system 100.

In one example, the method may further include a step of operating the app 1 or a clone of the app 1 by running the script when/before being requested to run the app 1 from the second client 20, and in this example, the app 1 or the cloned app is operated by the app control module 108 according to the script “before” the app stream of the app 1 or the cloned app is received/used by the user on the second client 20, which means when the user starts to run the app 1/cloned app from the second client 20, the app 1/cloned app is already in a certain condition/status/configuration (e.g., in certain page of the app 1/cloned app). In another example, the method may further include a step of operating the app 1/cloned app by running the script “when” being requested to run the app 1 from the second client 20. It means the app control module 108 is initiated to operate the app 1/cloned app based on the script only when the advertising system 100 receives the request from the user on the second client 20.

In one example, the method may further include steps of inputting the input event to the app 1 run in the mobile OS 102 in the first virtual machine 101, and generating an image file after the app 1 takes a response to the input event. In this example, the image file includes at least one of the app 1/cloned app, the mobile OS 102/a clone of the mobile OS 102, the first virtual machine 101/a clone of the first virtual machine 101 and configuration of the first virtual machine. In this example, the image file is capable of being used to recover or to clone at least one of the app 1, the mobile OS 102 and the first virtual machine 101, wherein the mobile OS 102 or the first virtual machine 101 may include a cloned/recovered app 1 that runs on it. In this example, the cloned/recovered app 1 may be activated in a condition same/similar to the condition at the time when the app 1 takes response to the input event (when the input event is inputted to the app 1).

In one example, the method may further include the steps of generating the second virtual machine 101′ with the image file when/before being requested to run the app from a second client 20. In this example, and streaming an app stream of the recovered app 1 run on the second virtual machine to the second client 20.

In one example, the method may further include the steps of inputting the input event to the app 1 run on the first virtual machine 101, and storing a configuration of the app 1 after the app 1 takes a response to the input event. In another example, the method may further include the step of configuring the app 1 or a clone of the app 1 (the cloned app) based on the stored configuration when/before being requested to run the app 1 from the second client 20.

FIG. 5B is a flowchart illustrating methods of advertising apps according to an example of the present invention. Referring to FIG. 5B, similarly, the first part 15 of the user interface 200 is provided on the first client 10 for transmitting the app package of the app 1 to the advertising system 100 in step 502. In step 508, the third part 16 of the user interface 200 for transmitting a script or a configuration of the app 1 to the advertising system 100 is provided. In step 510, the script or the configuration is stored in the advertising system 100 (e.g., in the app repository 106).

In one example, the method may further include the step of operating the app 1 by running the script when/before being requested to run the app 1 from/by the second client 20, wherein the app 1 is capable of being started in the condition after being operated with the script when being requested to run from the second client 20.

In one example, the method may further include the steps of cloning the app 1 or installing the app package to the second virtual machine 101′ to form a cloned app in the second virtual machine 101′, and operating the cloned app with the script when/before being requested to run the app from/by the second client 20. In this example, the cloned app is capable of being started in a condition after being operated with the script when being requested to run from the second client 20.

In one example, the method may further include the step of configuring the app 1 based on the stored configuration when/before being requested to run the app 1 from/by a second client 20.

In one example, the method may further include the steps of cloning the app 1 or installing the app package to the second virtual machine 101′ to form a cloned app in the second virtual machine 101′, and configuring the cloned app with the configuration when/before being requested to run the app from/by the second client 20, wherein the cloned app is capable of being started in a condition after being configured with the configuration when being requested to run from the second client 20.

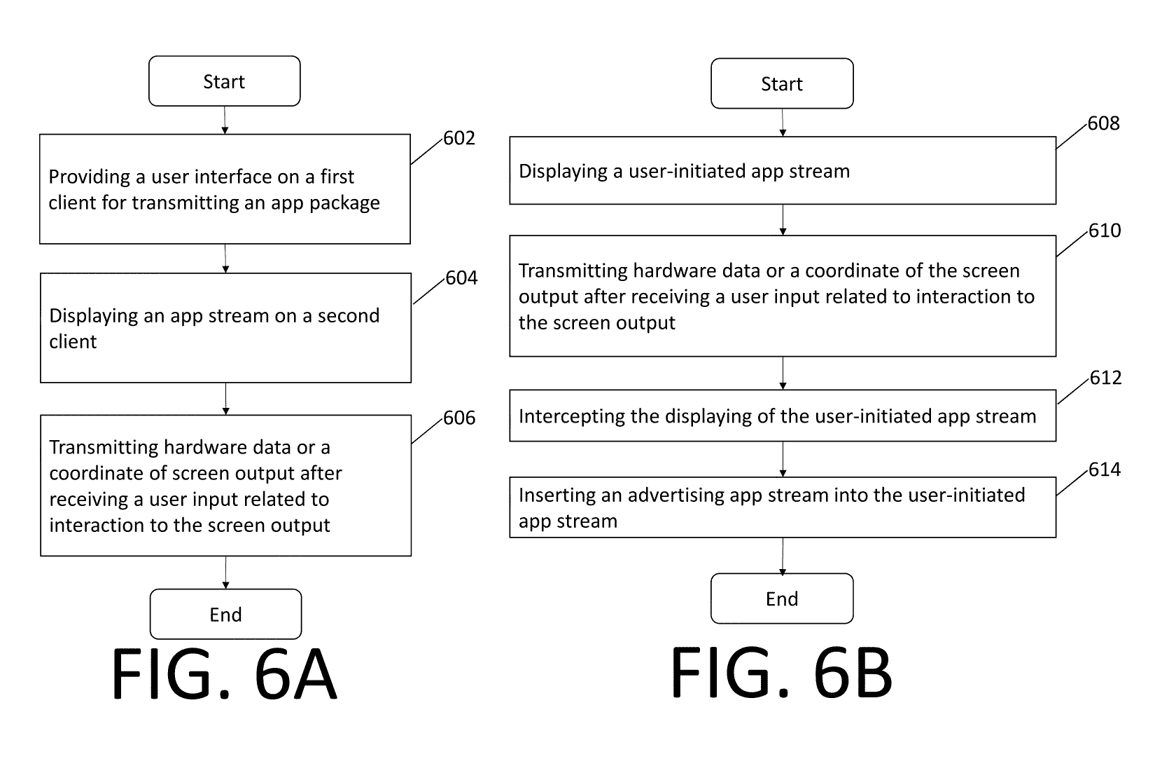

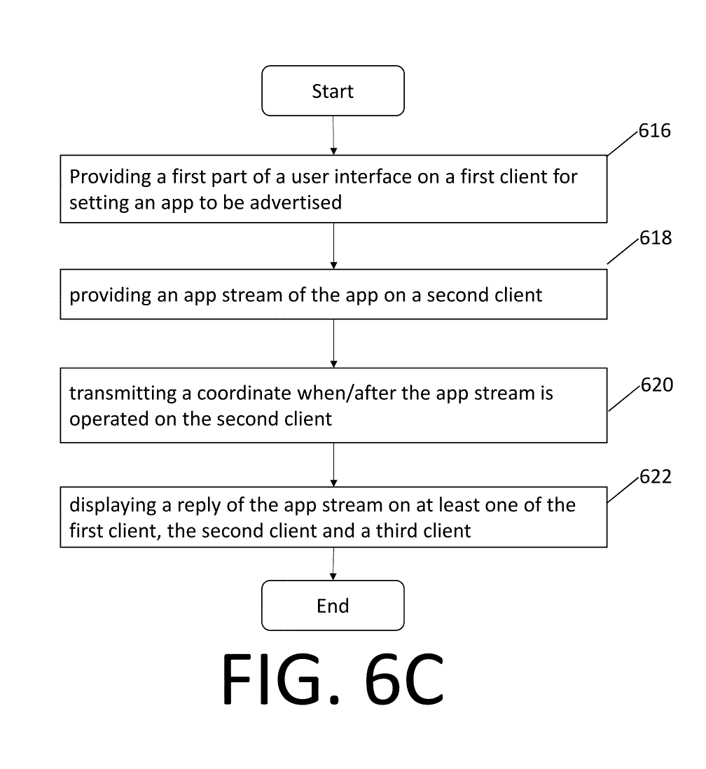

FIG. 6A is a flowchart illustrating methods of advertising apps according to an example of the present invention. Referring to FIG. 6A, in step 602, the user interface 200 is provided on the first client 10 for transmitting the app package of the app 1 to the advertising system 100, wherein the app package is transmitted to be installed in the virtual machine 101 to form the app 1 run on the virtual machine 101. In step 604, an app stream transmitted from the advertising system 100 is displayed on the second client 20, wherein the app stream includes screen outputs of the app 1 and each screen output includes pixels (or pixel data) corresponding to the surface where the app 1 renders its content or at least one of a texture and a corresponding command to draw the screen output on the second client 20. In step 606, hardware data or a coordinate of the screen output is transmitted to the advertising system after receiving a user input related to interaction with/on/to the screen output.

In one example, the step 602 may further include the steps of providing the first part 15 of the user interface 200 on the first client 10 for transmitting the app package of the app 1 to the advertising system 100, and providing the second part 11 of the user interface 200 to display the app stream of the app 1.

In one example, the method may further include the step of generating an input event after receiving the hardware data or the coordinate.

In one example, the method may further include the steps of generating a script based on the input event, and storing the script in the advertising system 100. In another example, the method may further include the step of operating the app 1 or a clone of the app 1 by running the script when/before being requested to run the app 1 from the second client 20.

In one example, the method may further include the steps of inputting the input event to the app 1 run on the first virtual machine 101, and storing/freezing/keeping/ghosting (i.e. to make an image file or a clone of) the first virtual machine 101 after the app 1 in the virtual machine 101 takes a response to the input event.

In one example, the method may further include the steps of cloning the first virtual machine 101 to form a new virtual machine (e.g., the second virtual machine 101′) including a cloned app of the app 1 when/before being requested to run the app 1 from the second client 20, wherein the cloned app is capable of being executed from being in a status similar to the status of the app 1 after taking the response to same/similar input event (or the input event).

In one example, the method may further include steps of inputting the input event to the app 1 run on the first virtual machine 101, and storing a configuration of the app 1 or the first virtual machine 101 after the app 1 in the virtual machine 101 takes a response to the input event.

In one example, the method may further include the step of configuring the app 1 or the cloned app (of the app 1) based on the stored configuration when/before being requested to run the app from a second client.

FIG. 6B is a flowchart illustrating methods of advertising apps according to an example of the present invention. Referring to FIG. 6B, in step 608, a user-initiated app stream transmitted from the advertising system 100 is displayed on the second client 20. The user-initiated app stream includes screen outputs of a user-selected app of which each screen output includes pixels corresponding to a first surface where the user-selected app renders its content or at least one of a texture and a corresponding command to draw the output screen of the user-selected app on the second client 20. In step 610, hardware data or a coordinate of the screen output is transmitted from the second client 20 to the advertising system 100 after receiving a user input related to interaction to the screen output. In step 612, on the second client 20 the displaying of the user-initiated app stream is intercepted. In step 614, an advertising app stream is inserted into the user-initiated app stream. In this example, the advertising app stream includes screen outputs of an advertised app of which each screen output includes pixels corresponding to a second surface where the advertised app renders its content or at least one of a texture and a corresponding command to draw the output screen of the advertised app on the second client 20.

In one example, the advertising app stream may be inserted before a beginning of the user-initiated app stream in step 614. In another example, advertising app stream may be inserted during streaming the user-initiated app stream in step 614. In this example, the user-initiated app stream is stopped/paused and all the status/condition/configuration of the user-selected app is kept/freezed for resuming streaming of the user-initiated app stream after the inserted advertising app stream is finished or skipped. In another example, the status/condition/configuration may be kept/freezed by keeping all the virtual machine running the user-selected app stopped/paused/freezed, and the resuming of the user-initiated app stream is to resume the stopped/paused/freezed virtual machine.

In one example, the method may further include the step of providing a skip button (e.g., the skip button 306a in FIG. 3D) for skipping the advertising app stream and switching to the user-initiated app stream.

In one example, the method may further include the step of providing the user interface 200 on the first client 10 for transmitting the app package to the advertising system 100, wherein the app package is installed in the virtual machine 101 in the advertising system 100 to form the advertised app run on the virtual machine 101. The screen outputs of the advertised app may be streamed/transmitted as the advertising app stream.

In one example, the method may further include the step of generating an input event after receiving the hardware data or the coordinate to the advertised app on the first virtual machine 101.

In other examples of the present invention, different kinds of app streams of/related to different apps may be intercepted/concatenated/combined to become a combination of the app streams. For example, a plurality of mobile gaming apps may be played sequentially when app streams of each of the mobile gaming apps is concatenated to become one app stream combo. In one example, a starting point/breakpoint may be added at the beginning of an app stream in the app stream combination (which could be the app stream of a certain mobile gaming app in the plurality of mobile gaming apps) and a skip button or a “next”/“previous” button may to displayed with the app stream combo. In this example, when a user is operating/playing the app stream combo, he/she may skip the current one to the previous/next app stream started at the starting point in the app stream combo.

FIG. 6C is a flowchart illustrating methods of advertising apps according to an example of the present invention. Referring to FIG. 6C, in step 616, the first part 15 of the user interface 200 may be provided on the first client 10 for setting the app 1 to be advertised (e.g., the app 1). In step 618, an app stream of the app 1 may be provided on the second client 20. In this example, the app stream may be streamed from the streaming server 104 to the second client 20. For example, the app stream may be displayed/shown on a window/screen output (a user interface) like the window(s) 306, 307, 308, 404 and/or 408. In this example, the app stream displayed/shown on the window/user interface is capable of being operated on the second client 20 like the app is being operated. In step 620, a coordinate corresponding to where the app stream is operated/touched/clicked by a user (i.e., the coordinate on the window/user interface) may be transmitted to the streaming server 104 when/after the app stream is operated on the second client 20.

After receiving the coordinate, in one example, an input event may be generated by the app control module 108 in response to the coordinate, and the input event may is used to input or to operate the app 1. When/after the app 1 takes response to the input event, if the output screen of the app 1 is changed, a new app stream(s) may be streamed to the second client 20 by the streaming server 104, and so on. In one example, the received coordinate may first be stored in the app repository 106 (and thus the app repository 106 may store a plurality of coordinates/coordinate sequences). When being request for replying the app stream, since the app 1 can behave in response to the same sequence of input events, the stored coordinates/coordinate sequences can be converted to corresponding input events again (by the app control module 108), and output screens of the app 1 when/after the app 1 takes responses to the input events can again be streamed as the replayed app stream (a reply of the app stream when being operated by the user before) to one who requests for seeing the reply (e.g., advertisers/audiences or other users on the first client 10, the second client 20 or other clients).

In another example, the script generating module 112 can be configured to generate a script (namely, e.g., a “reply script”) comprising the input event/coordinate for operating the app 1 based on the coordinate (similar with those described above), that is, a sequence/series of coordinates/input events can operate the app 1 to perform certain functions or display certain screen outputs/UIs, for example, touch a button, and then pull out a drawer/sidebar, and touch another button on it, and so on. In this example, the app repository 106 can store the input event, the coordinate or the reply script (refer to the script described above, the script can actually include/describe input events and/or the coordinates). In the above two example, the user behaviors to the app 1 is therefore being recorded/stored in the app repository 106 (and of course one skilled in the art can understand that other storage or repository can also be used to store the script, the input event or the coordinate).

When the advertiser of the app 1 want to see/check how the user/an audience operate the app 1 when seeing the advertisement (including the app stream) he/she sets for the app 1, he/she can request to see the reply of the app stream by picking up/selecting one of the recorded user behaviors (e.g., there may be a list/table of various kinds of user behavior records to the app stream of the app 1 for the advertiser to choose for seeing/checking corresponding replies). By the help of the reply of the app stream (or a plurality replies of app streams generated when/after different users' operation to the app 1), the advertiser can know more about how users/audiences use the app 1 or what/where the most attractive part of the app 1, and this is helpful for the advertiser to develop/modify the app 1, or the advertisement of the app 1. The reply of how the app 1 is operated may provide more user behavior information than the conventional/traditional advertisement of apps which may only provide statistic/static data such as counts of clicks and/or downloads.

In still another example, the method of the present invention can further include the steps of receiving a request for replying the app stream, operating the app 1 or a cloned app of the app 1 by running the script, and streaming the screen outputs of the app 1 or the cloned app as the replay of the app stream.

In yet another example, the method of the present invention can further include the steps of recording the app stream to form a video when/after the app is operated and transmitting the video to at least one of the first client 10, the second client 20 and the third client (not shown). In this example, the video can be stored in the app repository 106 or other storage (not shown) in or coupled with the system of the present invention. In this example, the whole file of the video can be transmitted to the client(s) and be played/replayed by applications (such as a video player) on the client(s).

In other example, the method of the present invention can further include the steps of recording the app stream to form a video when/after the app is operated and transmitting the video to at least one of the first client 10, the second client 20 and the third client (not shown). In this example, similarly, the video can be stored in the app repository 106 or other storage (not shown) in or coupled with the system of the present invention. However, in this example, the whole file of the video won't be transmitted to the client(s) first, but streamed piece-by-piece (part-by-part) to the client(s) to be played/replayed on the client(s).

It may be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art may readily appreciate that the sequences may be varied and still remain within the spirit and scope of the present invention.

We claim:

1. A method for advertising apps, the method comprising the steps of:
providing a first part of a user interface on a first client for setting an app to be advertised;
providing an app stream of the app on a second client,
wherein the app stream is capable of being operated on the second client as the app is being operated;
transmitting a coordinate when/after the app stream is operated on the second client; and
displaying a reply of the app stream on at least one of the first client, the second client and a third client.

2. The method of claim 1 further comprising the step of:
storing the coordinate.

3. The method of claim 1 further comprising the step of:
generating an input event in response to the coordinate.

4. The method of claim 1 further comprising the step of:
generating a script for operating the app based on the coordinate.

5. The method of claim 4, wherein the script comprises at least one of the coordinate and an input event.

6. The method of claim 4 further comprising the step of:
storing the script.

7. The method of claim 4 further comprising the steps of:
receiving a request for replying the app stream;
operating the app or a cloned app of the app by running the script; and
streaming the screen outputs of the app or the cloned app as the replay of the app stream.

8. The method of claim 1 further comprising the steps of:
recording the app stream to form a video when/after the app is operated; and
transmitting the video to at least one of the first client, the second client and the third client.

9. The method of claim 1 further comprising the step of:
recording the app stream to form a video when/after the app is operated; and
streaming the video to at least one of the first client, the second client and the third client.

10. An advertising system comprising:
an application server configured to provide a first part of a user interface on a first client for setting an app to be advertised;
a virtual machine,
wherein an app package related to the app is installed in the virtual machine to form the app run on the virtual machine; and
a streaming server configured to stream an app stream to a second part of the user interface to display the app stream on the second part of the user interface, and receive a coordinate of the second part of the user interface,
wherein the app stream shows pixels of a surface where the app renders its content, and
the coordinate is transmitted when/after the app stream is operated.

11. The system of claim 10 further comprising:
an app repository configured to store the coordinate, a script for running the app or a configuration of the app after the app stream is operated.

12. The system of claim 11 further comprising:
a scrip generating module configured to generate the scrip based on the coordinate.

13. The system of claim 11 further comprising:
a scrip uploading module configured to receive the scrip from the first client.

14. The system of claim 11 further comprising:
an app control module configured to operate the app or a cloned app of the app by running the script when/before being requested to run the app from a second client.

15. The system of claim 10, wherein the application server is further configured to provide a third part of the user interface for transmitting a script for running the app or a configuration of the app to the advertising system;

16. An advertising system comprising:
an application server configured to provide a first part of a user interface on a first client for setting an app to be advertised;
a virtual machine,
wherein an app package related to the app is installed in the virtual machine to form the app run on the virtual machine;
a streaming server configured to provide an app stream of the app to a second client and receive a coordinate when/after the app stream is operated on the second client,
wherein the app stream is capable of being operated on the second client as the app is being operated;
a scrip generating module configured to generate a scrip based on the coordinate; and
an app control module configured to operate the app or a cloned app of the app by running the script when/before being requested for displaying a reply of the app stream from at least one of the first client, the second client and a third client.

17. The system of claim 16 further comprising:
an app repository configured to store the coordinate.

18. The system of claim 16, wherein the script comprises at least one of the coordinate and an input event.

19. The system of claim 16, wherein the reply of the app stream comprises screen outputs of the app or the cloned app streamed after being operated by the app control module.

20. The system of claim 16, wherein the streaming server is further configured to store a video comprising the app stream as the reply of the app stream.
